(19) United States
(12) Patent Application Publication
(10) Pub. No.: US 2006/0234082 A1
(43) Pub. Date: Oct. 19, 2006

(54) Aluminum alloy brazing material, brazing member, brazed article and brazing method therefor using said material, brazing heat exchanginh tube, heat exchanger and manufacturing method thereof using said brazing heat exchanging tube

(75) Inventors: Kazuhiko Minami, Tochigi (JP); Tomoaki Yamanoi, Tochigi (JP); Hiroyuki Kawabata, Tochigi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SHOWA DENKO K.K., Tokyo (JP)

(21) Appl. No.: 10/538,657

(22) PCT Filed: Dec. 12, 2003
(86) PCT No.: PCT/JP03/15933

§ 371 Date: Nov. 3, 2005

Related U.S. Application Data
(60) Provisional application No. 60/451,262, filed on Mar. 4, 2003.

(30) Foreign Application Priority Data
Dec. 12, 2002 (JP) 2002-361130

(51) Int. Cl. B32B 15/10; B32B 15/01

(52) U.S. Cl. 428/650

(57) ABSTRACT

A heat exchanger includes a brazing heat exchanging tube and a fin. The heat exchanging tube and the fin are brazed with each other via the brazing layer of the heat exchanging tube. The brazing layer is formed by spraying a brazing material consisting of Si: 6 to 15 mass %, Zn: 1 to 20 mass %, at least one of Cu: 0.3 to 0.6 mass % and Mn: 0.3 to 1.5 mass, and the balance being aluminum and inevitable impurities.

Priority is claimed to Japanese Patent Application No. 2002-361130, filed on Dec. 12, 2002, and U.S. Provisional Application No. 60/451,262, filed on Mar. 4, 2003, the disclosure of which are incorporated by reference in their entireties.

### CROSS REFERENCE TO RELATED APPLICATIONS

This application is an application filed under 35 U.S.C. §111(a) claiming the benefit pursuant to 35 U.S.C. §119(e)(1) of the filing date of Provisional Application No. 60/451,262 filed on Mar. 4, 2003 pursuant to 35 U.S.C. §111(b).

### TECHNICAL FIELD

The present invention relates to an aluminum alloy brazing material, a brazing member, a brazed article using the brazing member and the manufacturing method thereof. The invention also relates to a heat exchanging tube required to have corrosion resistance for use in, for example, aluminum or aluminum alloy heat exchangers to be used as radiators as well as condensers, evaporators for use in automobile, household or commercial air-conditioners, a heat exchanger using the heat exchanging tube and the manufacturing method of the heat exchanger.

### BACKGROUND ART

As a heat exchanger to be used as an automobile radiator, a condenser or an evaporator for coolers, a heat exchanger having a heat exchanging core portion in which aluminum flat heat exchanging tubes and corrugated fins are disposed alternatively and brazed integrally with each other is well known.

In manufacturing such a heat exchanger, it is a well known technique to prevent corrosion of the heat exchanging tubes by preferential corrosion of the filets or to form a zinc (Zn) diffusion layer on a surface layer portion of the heat exchanging tube to thereby improve corrosion of the heat exchanger by sacrificial corrosion of the surface layer portion. According to a known method, for example, molten Al—Si—Zn series alloy brazing material is sprayed onto a surface of a heat exchanging tube to form a brazing layer, and a fin is brazed to the tube using the brazing layer to thereby attain the joining of the fin and the forming of a zinc diffusion layer (see, e.g., Japanese Unexamined Laid-open Patent Publication No. S59-10467, Table 4 and lines 9 to 12 of the left lower column on page 3), Japanese Patent No. 2,515,561, claim 1, etc., and Japanese Unexamined Laid-open Patent Publication No. H7-174482, claim 1, etc.)

For an oil cooler pipe, an Al—Si—Cu—Zn series alloy may sometimes be used as a low melting brazing material (e.g., Japanese Unexamined Laid-open Patent Publication No. H10-265881, claim 3, etc.)

In the case of a tube with the aforementioned sprayed Al—Si—Zn series alloy brazing material containing a large amount of Zn or a tube with sprayed Zn, although detachment of fins may occur due to the preferential corrosion of the fillets, it is considered that the corrosion resistance of the entire heat exchanger can be improved if the timing of the detachment of fins can be delayed. Furthermore, an existing heat exchanger is deep in tube corrosion depth due to the Zn diffusion layer. Therefore, in the case of a recently available tube with a thin thickness, it is difficult to secure a sufficient effective thickness.

Furthermore, in the case of employing the aforementioned brazing material of Al—Si—Cu—Zn series alloy as disclosed by Japanese Unexamined Laid-open Patent Publication No. H10-265881, since intergranular corrosion occurs due to the large amount of Cu (0.7 to 8.0 mass %) contained to lower the alloy melting point and improve the fluidity of the brazing material, there is a problem in corrosion resistance.

Even in cases where no corrosion in the form of intergranular corrosion occurs, adding Cu exceeding 0.7 mass % to a brazing material causes a deterioration of self-corrosion resistance accompanied by pitting type corrosion. Therefore, such a brazing material cannot be appropriately applied to a thin tube as mentioned above.

The aforementioned problems also occur at the time of brazing another brazing articles other than that of a heat exchanger.

### DISCLOSURE OF INVENTION

In view of the aforementioned technical background, the present invention aims to provide an aluminum alloy brazing material as an anticorrosion brazing material due to sacrificial corrosion capable of restraining detachment of brazed members and decreasing depth of corrosion, a brazing member using such an aluminum alloy brazing material, a brazed article using the brazing member, a method of manufacturing the brazing article, a brazing heat exchanging tube, a heat exchanger using the heat exchanging tubes, and a method of manufacturing the heat exchanger.

The aluminum alloy brazing material according to the present invention is defined by the following Items (1) to (5).

(1) An aluminum alloy brazing material, consisting essentially of:

Si: 6 to 15 mass %;

Zn: 1 to 20 mass %;

at least one of Cu: 0.3 to 0.6 mass % and Mn: 0.3 to 1.5 mass %; and

the balance being aluminum and impurities.

(2) The aluminum alloy brazing material as recited in the aforementioned Item (1), wherein the content of Si is 6 to 12.5 mass %.

(3) The aluminum alloy brazing material as recited in the aforementioned Item (1) or (2), wherein the content of Zn is 2 to 7 mass %.

(4) The aluminum alloy brazing material as recited in any one of the aforementioned Item (1) to (3), wherein the content of Cu is 0.4 to 0.55 mass %.

(5) The aluminum alloy brazing material as recited in any one of the aforementioned Items (1) to (4), wherein the content of Mn is 0.4 to 1 mass %.

The brazing member, the brazed article and the method of manufacturing the brazed article according to the present invention are defined by the following Items (6) to (9).

(6) A brazing member comprising an aluminum or aluminum alloy substrate and a brazing layer formed on a surface of the substrate, wherein the brazing layer is a sprayed layer of the aluminum alloy brazing material defined by any one of the aforementioned Items (1) to (5).

(7) A brazed article, comprising:

the brazing member defined by the aforementioned Item (6); and

a joining member,

wherein the brazing member and the joining member are brazed with each other via the brazing layer of the brazing member.

(8) A method of manufacturing a brazed article, comprising the steps of:

preparing a brazing member by spraying the aluminum alloy brazing material defined by any one of the aforementioned Items (1) to (5) onto a surface of an aluminum or aluminum alloy substrate to form a brazing layer; and

brazing the brazing member and another joining member via the brazing layer by heating both of the members in a combined manner.

(9) The method of manufacturing a brazed article as recited in the aforementioned Item (8), wherein the step of brazing is performed under normal pressures.

The brazing heat exchanging tube according to the invention is defined by the following Items (10) to (15).

(10) A brazing heat exchanging tube, comprising:

an aluminum or aluminum alloy heat exchanging tube substrate; and

a brazing layer formed on a surface of the heat exchanging tube substrate,

wherein the brazing layer is a sprayed layer of the aluminum alloy brazing material defined by any one of the aforementioned Items (1) to (5).

(11) The brazing heat exchanging tube as recited in the aforementioned Item (10), wherein the heat exchanging tube substrate is made of a JIS A1000 series alloy.

(12) The brazing heat exchanging tube as recited in the aforementioned Item (10), wherein the heat exchanging tube substrate is made of a JIS A3003 series alloy.

(13) The brazing heat exchanging tube as recited in the aforementioned Item (10), wherein the heat exchanging tube substrate is made of an Al—Cu—Mn series alloy containing Cu: exceeding 0.2 mass % but not exceeding 0.6 mass % and Mn: 0.15 to 2 mass %.

(14) The brazing heat exchanging tube as recited in the aforementioned Item (13), wherein, in the Al—Cu—Mn series alloy, the content of Cu is 0.25 to 0.5 mass %, and the content of Mn is 0.15 to 0.4 mass %.

(15) The brazing heat exchanging tube as recited in the aforementioned Item (13), wherein, in the Al—Cu—Mn series alloy, the content of Cu is 0.25 to 0.5 mass %, and the content of Mn is 0.6 to 1.5 mass %.

The heat exchanger according to the invention is defined by the following Items (16) to (22).

(16) A heat exchanger, comprising:

the brazing heat exchanging tube defined by the aforementioned Item (10); and

a fin,

wherein the heat exchanging tube and the fin are brazed with each other via the brazing layer of the heat exchanging tube.

(17) The heat exchanger as recited in the aforementioned Item (16), wherein the heat exchanging tube substrate of the brazing heat exchanging tube is a JIS A1000 series alloy.

(18) The heat exchanger as recited in the aforementioned Item (16), wherein the heat exchanging tube substrate of the brazing heat exchanging tube is a JIS A3003 series alloy.

(19) The heat exchanger as recited in the aforementioned Item (16), wherein the heat exchanging tube substrate of the brazing heat exchanging tube is made of an Al—Cu—Mn series alloy containing Cu: exceeding 0.2 mass % but not exceeding 0.6 mass % and Mn: 0.15 to 2 mass %.

(20) The heat exchanger as recited in the aforementioned Item (19), wherein, in the Al—Cu—Mn series alloy, the content of Cu is 0.25 to 0.5 mass %, and the content of Mn is 0.15 to 0.4 mass %.

(21) The heat exchanger as recited in the aforementioned Item (19), wherein, in the Al—Cu—Mn series alloy, the content of Cu is 0.25 to 0.5 mass %, and the content of Mn is 0.6 to 1.5 mass %.

(22) The heat exchanger as recited in any one of in the aforementioned Items (16) to (21), wherein the fin is made of a JIS A3000 series alloy.

The method of manufacturing a heat exchanger according to the invention is defined by the following Items (23) to (25).

(23) A method of manufacturing a heat exchanger, comprising the steps of:

preparing a brazing heat exchanging tube by spraying the aluminum alloy brazing material defined by any one of in the aforementioned Items (1) to (5) onto a surface of an aluminum or aluminum alloy heat exchanging tube substrate to form a brazing layer; and

brazing the brazing heat exchanging tube and a fin via the brazing layer of the brazing heat exchanging tube by heating both of the brazing heat exchanging tube and the fin in a combined manner.

(24) The method of manufacturing a heat exchanger as recited in the aforementioned Item (23), wherein the step of preparing the brazing heat exchanging tube is performed by forming the heat exchanging tube substrate by extrusion and subsequently spraying an aluminum alloy brazing material onto the heat exchanging tube substrate.

(25) The method of manufacturing a heat exchanger as recited in the aforementioned Item (23) or (24), wherein the step of brazing is performed under normal pressures.

According to the invention as recited in the aforementioned Item (1), Cu and Mn make the potential of the fillet higher to decrease the potential difference between the fillet and the joining member, thereby restraining excessive corrosion of the fillet and decreasing the corrosion depth due to the Zn sacrificial corrosion layer formed in the joining member. This can decrease the predetermined thickness of the joining member required so as not to generate pitting corrosion, resulting in an aluminum alloy brazing material capable of improving corrosion resistance while attaining weight saving of the brazed article.

According to the invention as recited in the aforementioned Item (2), an aluminum alloy brazing material excellent especially in brazing performance can be obtained.

According to the invention as recited in the aforementioned Item (3), an aluminum alloy brazing material excellent especially in corrosion resistance capable of forming an appropriate Zn diffusion layer can be obtained.

According to the invention as recited in the aforementioned Item (4), an aluminum alloy brazing material excellent especially in corrosion resistance capable of restraining excessive corrosion can be obtained.

According to the invention as recited in the aforementioned Item (5), an aluminum alloy brazing material excellent especially in corrosion resistance capable of restraining excessive corrosion can be obtained.

According to the invention as recited in the aforementioned Item (6), Cu and Mn make the potential of the fillet higher to decrease the potential difference between the fillet and the joining member, thereby restraining excessive corrosion of the fillet and decreasing the corrosion depth due to the Zn sacrificial corrosion layer formed in the joining member, resulting in an aluminum alloy brazing member excellent in corrosion resistance.

According to the invention as recited in the aforementioned Item (7), the brazing member and another joining member can be joined appropriately, resulting in a brazed article with excellent corrosion resistance.

According to the invention as recited in the aforementioned Item (8), the brazing member and another joining member can be joined appropriately, resulting in a brazed article with excellent corrosion resistance.

According to the invention as recited in the aforementioned Item (9), a Zn sacrificial corrosion layer can be appropriately formed in a surface portion of the substrate.

According to the invention as recited in the aforementioned Item (10), Cu and Mn make the potential of the fillet higher to decrease the potential difference between the fillet and the joining member, thereby restraining excessive corrosion of the fillet and decreasing the corrosion depth due to the Zn sacrificial corrosion layer formed in the joining member. This can decrease the tube thickness, resulting in a brazing heat exchanging tube light in weight and excellent in corrosion resistance.

According to the invention as recited in the aforementioned Item (11), a brazing heat exchanging tube excellent especially in corrosion resistance can be obtained.

According to the invention as recited in the aforementioned Item (12), a brazing heat exchanging tube excellent in corrosion resistance can be obtained.

According to the invention as recited in the aforementioned Item (13), a brazing heat exchanging tube excellent in corrosion resistance can be obtained.

According to the invention as recited in the aforementioned Item (14), a brazing heat exchanging tube excellent in corrosion resistance and extrusion workability can be obtained.

According to the invention as recited in the aforementioned Item (15), a brazing heat exchanging tube excellent in corrosion resistance and high temperature strength can be obtained.

According to the invention as recited in the aforementioned Item (16), a heat exchanger excellent in corrosion resistance in which the brazing heat exchanging tube and the fin are joined preferably can be obtained.

According to the invention as recited in the aforementioned Item (17), a heat exchanger excellent especially in corrosion resistance can be obtained.

According to the invention as recited in the aforementioned Item (18), a heat exchanger excellent in corrosion resistance can be obtained.

According to the invention as recited in the aforementioned Item (19), a heat exchanger excellent in corrosion resistance can be obtained.

According to the invention as recited in the aforementioned Item (20), a heat exchanger excellent in corrosion resistance can be obtained. Furthermore, the manufacturing efficiency of the tube and the shape accuracy thereof can be improved, resulting in excellent manufacturing efficiency and shape accuracy.

According to the invention as recited in the aforementioned Item (21), a heat exchanger excellent in corrosion resistance and high temperature strength can be obtained.

According to the invention as recited in the aforementioned Item (22), a heat exchanger excellent in corrosion resistance in which the brazing heat exchanging tube and the fin are joined preferably can be obtained.

According to the invention as recited in the aforementioned Item (23), a heat exchanger excellent in corrosion resistance in which the brazing heat exchanging tube and the fin are joined preferably can be manufactured.

According to the invention as recited in the aforementioned Item (24), a brazing heat exchanging tube excellent in adhesive performance between the heat exchanging tube substrate and the brazing layer can be manufactured efficiently at the step of manufacturing the brazing heat exchanging tube, which in turn can manufacture a heat exchanger excellent in corrosion resistance.

According to the invention as recited in the aforementioned Item (25), a Zn sacrificial corrosion layer can be formed in the surface portion of the heat exchanging tube in a preferable manner.

### BRIEF DESCRIPTION OF DRAWINGS

FIG. 1 is a front view showing a heat exchanger according to an embodiment of the present invention.

FIG. 2 is a perspective view showing a partial principle portion of the core portion of the heat exchanger.

FIG. 3 is a schematic cross-sectional view showing the joining state of the tube and the fin of the heat exchanger.

FIG. 4 is a graph showing the corrosion potential in the heat exchanger.

FIG. 5 is a schematic view showing a manufacturing method of a brazing member according to the present invention.

### BEST MODE FOR CARRYING OUT THE INVENTION

The aluminum alloy brazing material according to the present invention is used to manufacture various brazing members or brazed articles to ultimately improve the corrosion resistance of the brazed articles. Accordingly, the explanation of the aluminum alloy brazing material according to the present invention will be made together with the explanation of the brazed article.

As the aforementioned brazing member, a heat exchanging tube to be brazed with a fin for use in aluminum or aluminum alloy heat exchangers, such as condensers or evaporators for use in automobile, household or commercial air-conditioners, or radiators, can be exemplified. In the following explanation, “brazing member or brazing heat exchanging tube,” “substrate or heat exchanging tube substrate,” and “brazed article or heat exchanger” will be abbreviated as “brazing member, etc.,” “substrate, etc.,” and “brazed article, etc.,” respectively. The following explanation will be mainly directed to the case in which a brazing member is a brazing heat exchanging tube and a brazed article is a heat exchanger. However, it should be understood that in the present invention the brazing member and the brazed article are not limited to the above.

In a brazing member, etc. according to the present invention, an aluminum alloy brazing material according to the present invention is sprayed onto a surface of a substrate, etc., whereby a brazing material layer required for joining is given to the substrate, etc. By using this brazing member, etc., it becomes possible to manufacture a brazed article, etc.

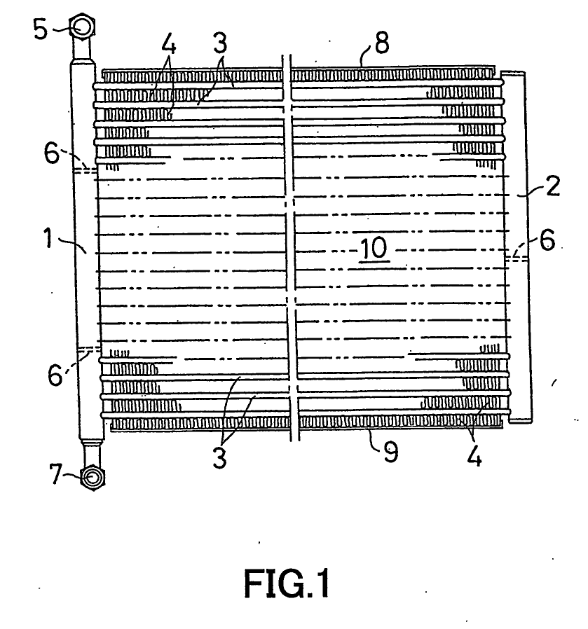

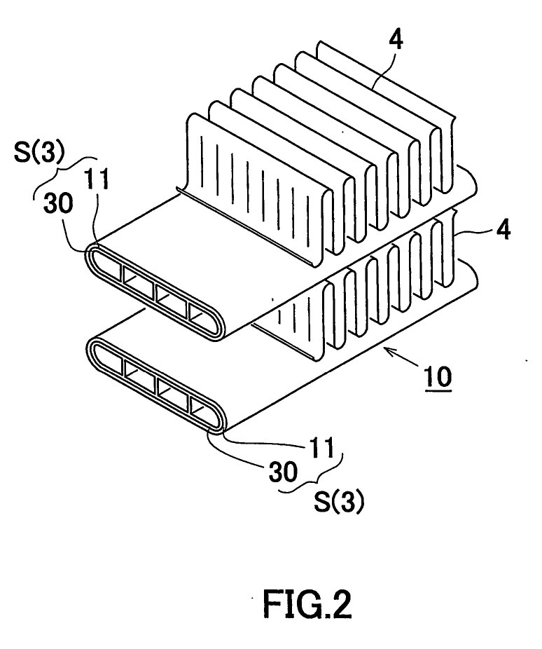

The aforementioned brazing member, etc. will be explained while taking a heat exchanging tube 3 which is a structural component of the heat exchanger shown in FIGS. 1 and 2 as an example with reference to drawings.

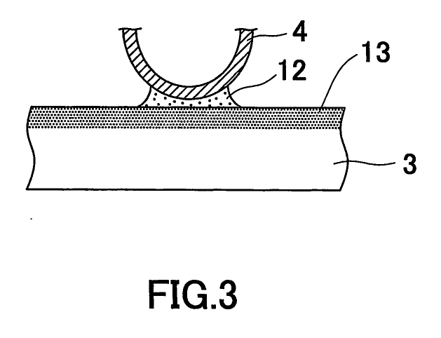

In the heat exchanger, fins 4 are brazed to the opposed external flat surfaces of the heat exchanging tube 3. As the heat exchanging tube 3, a brazing heat exchanging tube S according to the present invention in which a sprayed brazing layer 11 is formed on the external surface of the heat exchanging tube substrate 30 is used. FIG. 3 is a schematic partial cross-section showing the joint status in which the brazing heat exchanging tube S and the fin 4 are brazed to form a fillet 12. The reference numeral 13 denotes a Zn diffusion layer.

The brazing layer 11 is made of an aluminum alloy brazing material according to the present invention, and the composition thereof includes Si: 6 to 15 mass %, Zn: 1 to 20 mass %, at least one of Cu: 0.3 to 0.6 mass % and Mn: 0.3 to 1.5 mass %, and the balance being aluminum and impurities.

In the aforementioned aluminum alloy brazing material, Si lowers the melting point of the alloy to function as joining metal. If the Si content is less than 6 mass % or exceeds 15 mass %, the brazing performance deteriorates. Therefore, the Si content should fall within the range of 6 to 15 mass %. The preferable Si content is 6 to 12.5 mass %.

Zn diffuses into the surface layer portion of the heat exchanging tube substrate 30 of the tube exchanging tube 3 by the brazing heat to form a Zn diffusion layer 13, which improves the corrosion resistance of the heat exchanging tube 3 after the brazing. If the Zn content is less than 1 mass %, the absolute amount is insufficient, causing insufficient corrosion resistance effect. On the other hand, if the Zn content exceeds 20 mass %, the corrosion resistance of the fillet 12 to be formed by the brazing heat deteriorates, which may cause detachment of the fin 4 to be joined to another joining member such as a heat exchanging tube 3. Therefore, the Zn content should fall within the range of 1 to 20 mass %. The preferable Zn content is 2 to 7 mass %.

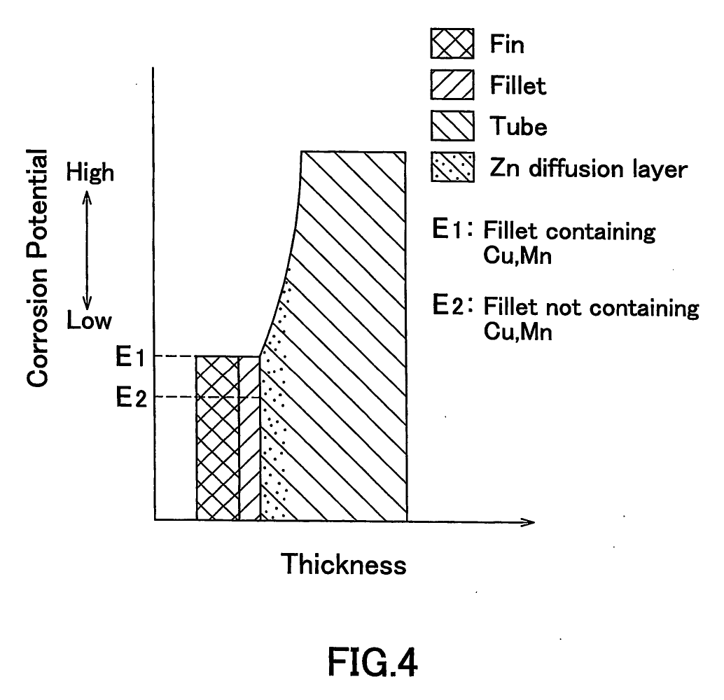

Cu and Mn are elements that make the corrosion potential of the brazing material higher. As shown in FIG. 4, in a conventional heat exchanger using a brazing material with no such elements, since the corrosion potential E2 of the fillet is lower than that of the fin, the fillet is easily corroded, causing an easy detachment of the fin. To the contrary, in the present invention, the corrosion potential E1 of the fillet 12 is shifted in the direction of higher corrosion potential by adding Cu and Mn to approach the corrosion potential of the fillet 12 to that of the fin 4, thereby restraining excessive corrosion of the fillet 12, which in turn can prevent the detachment of the fin 4. This also has the effect of decreasing the corrosion depth due to the sacrificial corrosion. In order to attain the aforementioned effects, it is enough to add either Cu or Mn, but both of them can be added. If the Cu content is less than 0.3 mass %, the aforementioned effects become insufficient. To the contrary, if the Cu content exceeds 0.6 mass %, intergranular corrosion occurs, which deteriorates the corrosion resistance. Accordingly, the Cu content should fall within the range of 0.3 to 0.6 mass %. The preferable Cu content is 0.4 to 0.55 mass %. Furthermore, if the Mn content is less than 0.3 mass %, the aforementioned effects become insufficient. To the contrary, if the Mn content exceeds 1.5 mass %, huge intermetallic compounds generate, which deteriorates the corrosion resistance. Accordingly, the Mn content should fall within the range of 0.3 to 1.5 mass %. The preferable Mn content is 0.4 to 1 mass %.

Al is contained in the brazing material as a matrix. Any impurities falling within the range that do not harm the brazing performance can be contained. Such impurities include Fe, In, Sn, Ni, Ti and Cr, for example.

The aluminum alloy brazing material according to the present invention can take any configuration, and can be made as, for example, an ingot, an extruded member, a drawn member, a rolled plate, a foil member, or powders.

The material of aluminum or aluminum alloy constituting the heat exchanging tube substrate 30 is not limited to a specific one, but may be any aluminum or aluminum alloy. As such an aluminum or aluminum alloy, JIS (Japanese Industrial Standards) A1000 series alloy, JIS A3003 alloy (Cu content: 0.05 to 0.2 mass %, Mn content: 1 to 1.5 mass %) can be preferably used. It is also preferable to utilize an Al—Cu—Mn series alloy containing more Cu and Mn than JIS A3003 alloy. It is recommended to use a tube made of one of the aforementioned alloys.

In JIS A1000 series alloy among the aforementioned three types of alloys, it is especially recommended to use JIS A1100 alloy, which has been widely used as tube materials.

The reason for recommending JIS A3003 or Al—Cu—Mn series alloy is as follows. By using a heat exchanging tube substrate 30 containing Cu and Mn, such Cu and Mn will be diffused in the fillet 12 to make the corrosion potential higher, resulting in an improved corrosion resistance of the fillet 12. This effect can be obtained or improved even in cases where the Cu content and the Mn content exceed those of JIS A3003 alloy. Therefore, in the brazing heat exchanging tube S according to the present invention, it is recommended to use JIS A3003 and Al—Cu—Mn series alloy containing more Cu and Mn as the material of the heat exchanging tube substrate 30.

The aforementioned Al—Cu—Mn series alloy contains Cu: exceeding 0.2 mass % but not exceeding 0.6 mass %, and Mn: 0.15 to 2 mass %. If the Cu content exceeds 0.6 mass %, intergranular corrosion tends to easily generate in the tube 3. Therefore, the upper limit of the Cu content should be 0.6 mass %. Further, if the Mn content exceeds 2 mass %, large intermetallic compounds generate, causing a deterioratin of formability. Therefore, the upper limit of the Mn content should be 2 mass %.

In the aforementioned Al—Cu—Mn series alloy composition, it is preferable that the Cu content is 0.25 to 0.5 mass % and the Mn content is 0.15 to 0.4 mass %. If the Cu content and the Mn content fall within the aforementioned respective range, the effect of making the fillet potential higher can be obtained and the extrusion workability can be improved. Accordingly, when manufacturing a tube by extrusion, the manufacturing efficiency can be improved and a tube excellent in accuracy of form can be obtained.

In the aforementioned Al—Cu—Mn series alloy composition, it is also preferable that the Cu content is 0.25 to 0.5 mass % and the Mn content is 0.6 to 1.5 mass %. If the Cu content and the Mn content fall within the aforementioned respective range, the effect of making the fillet potential higher can be obtained and excellent high temperature strength can be obtained. This enhances the durability of the heat exchanging tube, which in turn can enhance the durability of the heat exchanger.

The balance compositions of the Al—Cu—Mn series alloy are, for example, aluminum and impurities. The balance compositions, however, may include another element(s) unless the element(s) inhibits the aforementioned effects.

The aluminum or aluminum alloy constituting the fin 4 is not limited to a specific one, but can be various aluminum or aluminum alloys. It is preferable that the fin 4 is made of JIS A3000 series alloy (Al—Mn series alloy). As such an alloy, an Al—Mn: 1.2 mass % —Zn: 1 mass % alloy can be exemplified.

In the brazing heat exchanging tube S, the brazing layer 11 is formed by a thermal spraying method. The brazing layer 11 is not required to be formed on the entire external surface of the heat exchanging tube substrate 30, but is enough to be formed only on the portions to be brazed. Even if a brazing layer is not formed on the entire external surface, the molten brazing material goes around the entire external surface to thereby form an even Zn diffusion layer.

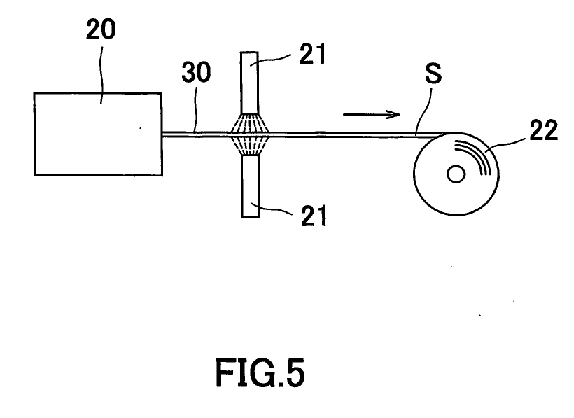

The thermal spraying method can be performed by a well known means. FIG. 5 shows an example of a method in which thermal spraying guns 21 are disposed at the outlet side of an extruder 20 for extruding a heat exchanging tube substrate 30 having a predetermined cross-section to continuously perform the molding of the tube substrate 30 and the forming of a brazing layer 11 on the tube substrate 30. With this method, the manufacturing of the brazing heat exchanging tube S is efficient. Furthermore, since the thermal spraying to the tube substrate 30 is performed immediately after the extrusion, i.e., before the cooling of the tube substrate 30, the excellent adhesiveness of the brazing layer 11 can be obtained. The aluminum alloy brazing material to be sprayed can be arbitrary selected from various materials including a rod shaped material and a powder type material that can be suitably used for the thermal spraying apparatus.

Next, a method of manufacturing a parallel flow type heat exchanger as shown in FIGS. 1 and 2 which is an example of a brazed article will be explained.

In FIG. 1, the reference numeral “1” and “2” denote a header, “3” denotes an aluminum or aluminum alloy heat exchanging tube, “4” denotes an corrugated fin, “5” denotes an inlet of the heat exchanging medium, “6” denotes an outlet of the heat exchanging medium, “8” and “9” denote a side plate, and “10” denotes a heat exchanger core portion.

As shown in FIG. 2, a plurality of brazing heat exchanging tubes S in which a brazing layer 11 is formed on the external surface of the heat exchanging tube substrate 30 are prepared. Then, the opposite ends of the tube S are inserted into the corresponding tube insertion apertures formed in the headers 1 and 2 at certain intervals in the longitudinal direction of the headers 1 and 2. Subsequently, a corrugated fin 4 is fitted into the space between the adjacent heat exchanging tubes S and S to form a heat exchanger assembly having a heat exchanging core portion 10.

Thereafter, the heat exchanger assembly is heated after applying flux thereto if necessary. This heating causes melting of the brazing layer 11 to thereby form a fillet 12 between the heat exchanging tube substrate 30 and the corrugated fin 4, which in turn causes excellent brazing of these members 30 and 4. In the manufactured heat exchanger core portion 10, since the corrosion potential of the fillet 12 approximates to that of the fin 4, the detachment of the fin 4 due to the preference corrosion of the fillet 12 can be restrained. Furthermore, Zn evenly diffuses in the surface layer portion of the heat exchanging tube substrate 30 at the time of the brazing to thereby form a Zn diffusion layer 13, resulting in improved corrosion resistance of the heat exchanging tube 3, which in turn improves the corrosion resistance of the entire heat exchanger.

The brazing can be performed under normal conditions. It is recommended to perform the brazing at normal pressures. However, vacuum brazing causes evaporation of Zn contained in the brazing layer 11. Therefore, the vacuum brazing may cause insufficient Zn diffusion layer, resulting in poor corrosion resistance.

### EXAMPLES

Brazing heat exchanging tubes in which a brazing material layer is formed on three types of heat exchanging tube substrates were manufactured. These brazing heat exchanging tubes and fins were assembled into a heat exchanging core and then brazed with each other to obtain a brazed article for evaluation. As the heat exchanging tube substrate material, JIS A1100 alloy was used in the following Manufacturing Example 1, JIS A3003 alloy was used in the following Manufacturing Example 2, and several Al—Cu—Mn series alloys were used in the following Manufacturing Example 3.

### Manufacturing Example 1

Brazing heat exchanging tubes Nos. 1 to 28 shown in Table 1 were manufactured.

As spraying bar-shaped materials for forming a brazing material layer, various aluminum alloy brazing materials shown in Table 1 and Zn were used. The content of Zn contained in an aluminum alloy brazing material will decrease due to the spraying of the brazing material. Therefore, in the column of the brazing material layer composition in Table 1, not the composition of each spraying bar-shaped material but the composition of each brazing material formed by the spraying, i.e., the composition of each aluminum alloy brazing layer to be used for brazing, is shown. The balance composition of each aluminum alloy brazing material is aluminum and impurities.

The manufacturing of each brazing heat exchanging tube was performed by using the extruder 20 and the thermal spraying guns 21 and 21 of arc spraying device disposed at the outlet side of the extruder 20. Initially, in the extruder 20, a flat shaped multi-bored tube 30 (see FIG. 2), 3 mm high×16 mm wide×0.5 mm wall-thick, was extruded. Subsequently, the spraying bar-shaped material was sprayed from the thermal spraying guns 21 and 21 onto the flat external surfaces of the multi-bored tube 30 immediately after the extrusion to form a brazing material layer 11 on the entire external surface of the multi-bored tube 30, water-cooled and then wounded to form a coil 22. Thus, a long and continuous brazing heat exchanging tube S was manufactured via the aforementioned steps. The sprayed amount of each of the brazing heat exchanging tubes Nos. 1 to 27 was 50 g/m². The sprayed amount of the Zn sprayed tube No. 28 was 10 g/m².

Next, the long and continuous brazing heat exchanging tube S was cut into pieces each having a length of 250 mm to manufacture a number of brazing heat exchanging tubes S shown in FIG. 2, and then subjected to the following brazing tests.

(Brazing Test)

The brazing heat exchanging tubes S and fins 4 made of Al—Mn: 1.2 mass % —Zn: 1 mass % alloy were fabricated into a multi-flow type heat exchanger core. Then, the core was immersed in flux liquid in which fluoride series flux was suspended in water and then dried. Thereafter, the core was heated in a N₂ gas atmosphere for 10 minutes at 600° C. at normal pressures.

The obtained brazed articles were subjected to the evaluation of the brazing performance with the following reference.

(Brazing Performance)

⊚: No erosion, Fin-Tube joining rate was not smaller than 95%
◯: Slight erosion, Fin-Tube joining rate was not smaller than 95%
Δ: Slight erosion, Fin-Tube joining rate was not smaller than 80% but less than 95%
X: Sevier erosion, Fin-Tube joining rate was smaller than 80%

These results are also shown in Table 1.

Furthermore, each brazed article was subjected to the CCT corrosion test (combined cycle corrosion test) and the SWAAT corrosion test under the following conditions. Then, the corrosion resistance was evaluated based on the fin detachment status and the tube corrosion depth (μm) with the following reference. The test pieces Nos. 26 and 27 were poor in brazing, and therefore were not subjected to corrosion tests.

(CCT Corrosion Test)

5% NaCl water solution was used as corrosion test liquid.

A cycle of spraying the corrosion test liquid for 1 hours →drying for 2 hours→wetting for 21 hours was repeated by 180 cycles.

(SWATT Corrosion Test)

As corrosive liquid, a mixture (pH 2.8 to 3) of artificial seawater and acetic acid according to the ASTM (American Society For Testing and Materials) standard was used.

A cycle of spraying the corrosion test liquid for 0.5 hours →drying for 1.5 hours was repeated for 960 hours.

(Fin Detachment Status)

⊚: After the SWATT test, the fin remaining rate was 90% or more
◯: After the SWATT test, the fin remaining rate was 60% or more but less than 90%
Δ: After the SWATT test, the fin remaining rate was 30% or more but less than 60%
X: After the SWATT test, the fin remaining rate was less than 30%
   (Corrosion Depth)

After the CCT corrosion test and after the SWAAT corrosion test, the corrosion depth (μm) in the opposite flat surfaces of the tube was measured. In each corrosion test, 9 pieces of 250 mm long tubes were used, and the largest corrosion depth was considered as the corrosion depth in each test.

These results are also shown in Table 1.

TABLE 1

| | | Brazing layer | | | | | | | | |
|---|---|---|---|---|---|---|---|---|---|---|
| | | composition (mass %) | | | | | | | SWAAT corrosion | |
| | | Balance: Al and | | | | | CCT corrosion test | | test | |
| | | impurities | | | | Brazing | Fin | Corrosion | Fin | Corrosion |
| No. | | Si | Zn | Cu | Mn | performance | detachment | depth (μm) | detachment | depth (μm) |
| Example | 1 | 6 | 4 | 0.5 | — | ⊚ | ⊚ | 104 | ⊚ | 88 |
| | 2 | 6 | 6 | 0.5 | — | ⊚ | ⊚ | 108 | ⊚ | 97 |
| | 3 | 7.5 | 3 | 0.5 | — | ⊚ | ⊚ | 100 | ⊚ | 80 |
| | 4 | 7.5 | 15 | 0.5 | — | ⊚ | ⊚ | 109 | ◯ | 98 |
| | 5 | 10 | 3 | 0.5 | — | ⊚ | ⊚ | 101 | ⊚ | 82 |
| | 6 | 10 | 6 | 0.6 | — | ⊚ | ⊚ | 107 | ⊚ | 94 |
| | 7 | 12 | 3 | 0.5 | — | ⊚ | ⊚ | 102 | ⊚ | 85 |
| | 8 | 12 | 6 | 0.4 | — | ⊚ | ⊚ | 108 | ⊚ | 96 |
| | 9 | 6 | 4 | — | 0.5 | ⊚ | ⊚ | 105 | ⊚ | 90 |
| | 10 | 6 | 6 | — | 0.5 | ⊚ | ⊚ | 107 | ⊚ | 94 |
| | 11 | 7.5 | 3 | — | 0.5 | ⊚ | ⊚ | 100 | ⊚ | 81 |
| | 12 | 7.5 | 15 | — | 0.8 | ⊚ | ⊚ | 109 | ◯ | 98 |
| | 13 | 10 | 3 | — | 0.4 | ⊚ | ⊚ | 102 | ⊚ | 84 |
| | 14 | 10 | 6 | — | 1.2 | ⊚ | ⊚ | 106 | ⊚ | 92 |
| | 15 | 12 | 3 | — | 0.5 | ⊚ | ⊚ | 101 | ⊚ | 82 |
| | 16 | 12 | 6 | — | 0.9 | ⊚ | ⊚ | 104 | ⊚ | 88 |
| | 17 | 7.5 | 3 | 0.5 | 0.5 | ⊚ | ⊚ | 100 | ⊚ | 80 |
| | 18 | 10 | 6 | 0.4 | 0.9 | ⊚ | ⊚ | 105 | ⊚ | 90 |
| Comparative | 19 | 7.5 | 3 | — | — | ⊚ | ⊚ | 135 | ◯ | 123 |
| Example | 20 | 7.5 | 3 | 0.8 | — | ⊚ | ⊚ | 170 | ◯ | 160 |
| | 21 | 7.5 | 3 | — | 1.7 | ⊚ | ⊚ | 136 | ◯ | 124 |
| | 22 | 7.5 | 3 | 0.1 | — | ⊚ | ⊚ | 132 | ◯ | 120 |
| | 23 | 7.5 | 3 | — | 0.1 | ⊚ | ⊚ | 134 | ◯ | 121 |
| | 24 | 7.5 | 60 | — | — | ⊚ | ◯ | 140 | X | 138 |
| | 25 | 7.5 | 0.5 | — | — | ⊚ | ◯ | 160 | ◯ | 150 |
| | 26 | 20 | 4 | — | — | X | — | — | — | — |
| | 27 | 4 | 4 | — | — | X | — | — | — | — |

| | | | | | | |
|---|---|---|---|---|---|---|
| 28 | Zn sprayed tube | ⊚ | ◯ | 148 | Δ | 102 |
| | (10 g/m²) | | | | | |

The results shown in Table 1 reveals that the brazed article of each Example using the predetermined aluminum alloy is excellent in corrosion resistance.

### Manufacturing Example 2

JIS A3003 alloy having the composition shown in Table 2 was used as a heat exchanging tube substrate material. A flat shaped multi-bored extruded tube 30 was formed by the same method as Manufacturing Example 1, then a spraying bar-shaped material was sprayed onto the opposite flat surfaces of the multi-bored tube immediately after the extrusion to form a brazing material layer 11. Thereafter, the tube was water-cooled and then wounded to form a coil 22. Thus, a long and continuous brazing heat exchanging tube S was manufactured via the aforementioned steps. Each composition of the brazing material layer 11 formed by the spraying method was shown in Nos. 31 to 38, respectively. The sprayed amount in each brazing heat exchanging tube was 50 g/m².

TABLE 2
A3003 composition (mass %) Balance: Al and impurities

| Si | Fe | Cu | Mn | Mg | Cr | Zn | Ti |
|---|---|---|---|---|---|---|---|
| 0.1 | 0.37 | 0.1 | 1 | — | — | — | 0.01 |

Next, in the same manner as in Manufacturing Example 1, the brazing heat exchanging tubes S, 250 mm long, and the fins 4 were fabricated into a core and brazed under the same conditions.

The brazing performance of each obtained brazed article was evaluated with the same reference.

Furthermore, each brazed article was subjected to the CCT corrosion test (combined cycle corrosion test) and the SWAAT corrosion test in the same manner as in Manufacturing Example 1. Thereafter, the fin detachment status and the tube corrosion depth (μm) were also evaluated.

These results are also shown in Table 3.

TABLE 3

| | | Brazing material | | | | | | | | |
|---|---|---|---|---|---|---|---|---|---|---|
| | | composition (mass %) | | | | | | | SWAAT corrosion | |
| | | Balance: Al and | | | | | CCT corrosion test | | test | |
| | | impurities | | | | Brazing | Fin | Corrosion | Fin | Corrosion |
| No. | | Si | Zn | Cu | Mn | performance | detachment | depth (μm) | detachment | depth (μm) |
| Example | 31 | 7.5 | 10 | — | 1 | ⊚ | ⊚ | 102 | ⊚ | 90 |
| | 32 | 10 | 6 | 0.35 | — | ⊚ | ⊚ | 97 | ⊚ | 87 |
| | 33 | | 10 | 0.35 | — | ⊚ | ⊚ | 101 | ⊚ | 88 |
| | 34 | | | 5 | — | ⊚ | ⊚ | 100 | ⊚ | 87 |
| | 35 | | 15 | 0.35 | — | ⊚ | ⊚ | 102 | ⊚ | 89 |
| | 36 | | | 0.5 | — | ⊚ | ⊚ | 100 | ⊚ | 87 |
| | 37 | 12 | 10 | 0.4 | — | ⊚ | ⊚ | 99 | ⊚ | 86 |
| | 38 | | 15 | 0.4 | — | ⊚ | ⊚ | 101 | ⊚ | 90 |

The results shown in Table 3 reveals that the brazed article of each Example is excellent in corrosion resistance.

### Manufacturing Example 3

Al—Cu—Mn alloys Nos. 41 to 49 each having the composition shown in Table 4 were used as heat exchanging tube materials. A flat shaped multi-bored extruded tube 30 was formed by the same method as Manufacturing Example 1, then a spraying bar-shaped material was sprayed onto the opposite flat surfaces of the multi-bored tube 30 immediately after the extrusion to form a brazing material layer 11. Thereafter, the tube was water-cooled and then wounded to form a coil 22. Thus, a long and continuous brazing heat exchanging tube S was manufactured via the aforementioned steps. In each Example, the same spraying bar-shaped material was used, and the composition of the brazing material layer 11 formed by the spraying method was Si: 10 mass %, Zn: 5 mass %, Cu: 0.4 mass %, and the balance being Al and impurities. The sprayed amount in each brazing heat exchanging tube was 50 g/m².

Next, in the same manner as Manufacturing Example 1, the brazing heat exchanging tubes S, 250 mm long, and the fins 4 were fabricated into a core and brazed under the same conditions.

The brazing performance of each obtained brazed article was evaluated with the same reference.

Furthermore, each brazed article was subjected to the CCT corrosion test (combined cycle corrosion test) and the SWAAT corrosion test in the same manner as in Manufacturing Example 1. Thereafter, the fin detachment status and the tube corrosion depth (μm) were also evaluated.

These results are also shown in Table 4.

TABLE 4

| | | Tube | | | | | | |
|---|---|---|---|---|---|---|---|---|
| | | composition (mass %) | | | | | SWAAT corrosion | |
| | | Balance: Al and | | | CCT corrosion test | | test | |
| | | impurities | | Brazing | Fin | Corrosion | Fin | Corrosion |
| No. | | Cu | Mn | performance | detachment | depth (μm) | detachment | depth (μm) |
| Example | 41 | 0.21 | 0.15 | ⊚ | ⊚ | 105 | ⊚ | 87 |
| | 42 | | 2 | ⊚ | ⊚ | 104 | ⊚ | 85 |
| | 43 | 0.25 | 0.2 | ⊚ | ⊚ | 105 | ⊚ | 85 |
| | 44 | | 1 | ⊚ | ⊚ | 104 | ⊚ | 84 |
| | 45 | 0.3 | 1.5 | ⊚ | ⊚ | 103 | ⊚ | 83 |
| | 46 | 0.4 | 0.2 | ⊚ | ⊚ | 103 | ⊚ | 82 |
| | 47 | | 1 | ⊚ | ⊚ | 102 | ⊚ | 80 |
| | 48 | 0.6 | 0.15 | ⊚ | ⊚ | 100 | ⊚ | 80 |
| | 49 | | 2 | ⊚ | ⊚ | 98 | ⊚ | 79 |

Brazing material layer: Si: 10 mass %, Zn: 5 mass %, Cu: 0.4 mass %, Balance being Al and impurities

The results shown in Table 4 reveals that the brazed article of each Example is excellent in corrosion resistance.

The terms and expressions which have been employed herein are used as terms of description and not of limitation, and there is no intent, in the use of such terms and expressions, of excluding any of the equivalents of the features shown and described or portions thereof, but it is recognized that various modifications are possible within the scope of the invention claimed.

### INDUSTRIAL APPLICABILITY

The aluminum alloy brazing material according to the present invention is capable of restraining a corrosion depth when it is used as a brazing corrosion resistance material due to sacrificial corrosion, and therefore can be used when manufacturing an aluminum brazed article such as a heat exchanger required to have corrosion resistance.

1. An aluminum alloy brazing material, consisting essentially of:
Si: 6 to 15 mass %;
Zn: 1 to 20 mass %;
at least one of Cu: 0.3 to 0.6 mass % and Mn: 0.3 to 1.5 mass; and
the balance being aluminum and impurities.

2. The aluminum alloy brazing material as recited in claim 1, wherein the content of Si is 6 to 12.5 mass %.

3. The aluminum alloy brazing material as recited in claim 1, wherein the content of Zn is 2 to 7 mass %.

4. The aluminum alloy brazing material as recited in claim 1, wherein the content of Cu is 0.4 to 0.55 mass %.

5. The aluminum alloy brazing material as recited in claim 1, wherein the content of Mn is 0.4 to 1 mass %.

6. A brazing member comprising an aluminum or aluminum alloy substrate and a brazing layer formed on a surface of the substrate, wherein the brazing layer is a sprayed layer of the aluminum alloy brazing material defined by claim 1.

7. A brazed article, comprising:
the brazing member defined by claim 6; and
a joining member,
wherein the brazing member and the joining member are brazed with each other via the brazing layer of the brazing member.

8. A method of manufacturing a brazed article, comprising the steps of:
preparing a brazing member by spraying the aluminum alloy brazing material defined by claim 1 onto a surface of an aluminum or aluminum alloy substrate to form a brazing layer; and
brazing the brazing member and another joining member via the brazing layer by heating both of the members in a combined manner.

9. The method of manufacturing a brazed article as recited in claim 8, wherein the step of brazing is performed under normal pressures.

10. A brazing heat exchanging tube, comprising:
an aluminum or aluminum alloy heat exchanging tube substrate; and
a brazing layer formed on a surface of the heat exchanging tube substrate,
wherein the brazing layer is a sprayed layer of the aluminum alloy brazing material defined by claim 1.

11. The brazing heat exchanging tube as recited in claim 10, wherein the heat exchanging tube substrate is made of a JIS A1000 series alloy.

12. The brazing heat exchanging tube as recited in claim 10, wherein the heat exchanging tube substrate is made of a JIS A3003 series alloy.

13. The brazing heat exchanging tube as recited in claim 10, wherein the heat exchanging tube substrate is made of an Al—Cu—Mn series alloy containing Cu: exceeding 0.2 mass % but not exceeding 0.6 mass % and Mn: 0.15 to 2 mass %.

14. The brazing heat exchanging tube as recited in claim 13, wherein, in the Al—Cu—Mn series alloy, the content of Cu is 0.25 to 0.5 mass %, and the content of Mn is 0.15 to 0.4 mass %.

15. The brazing heat exchanging tube as recited in claim 13, wherein, in the Al—Cu—Mn series alloy, the content of Cu is 0.25 to 0.5 mass %, and the content of Mn is 0.6 to 1.5 mass %.

16. A heat exchanger, comprising:
the brazing heat exchanging tube defined by claim 10; and
a fin,
wherein the heat exchanging tube and the fin are brazed with each other via the brazing layer of the heat exchanging tube.

17. The heat exchanger as recited in claim 16, wherein the heat exchanging tube substrate of the brazing heat exchanging tube substrate is a JIS A1000 series alloy.

18. The heat exchanger as recited in claim 16, wherein the heat exchanging tube substrate of the brazing heat exchanging tube is a JIS A3003 series alloy.

19. The heat exchanger as recited in claim 16, wherein the heat exchanging tube substrate of the brazing heat exchanging tube is made of an Al—Cu—Mn series alloy containing Cu: exceeding 0.2 mass % but not exceeding 0.6 mass % and Mn: 0.15 to 2 mass %.

20. The heat exchanger as recited in claim 19, wherein, in the Al—Cu—Mn series alloy, the content of Cu is 0.25 to 0.5 mass %, and the content of Mn is 0.15 to 0.4 mass %.

21. The heat exchanger as recited in claim 19, wherein, in the Al—Cu—Mn series alloy, the content of Cu is 0.25 to 0.5 mass %, and the content of Mn is 0.6 to 1.5 mass %.

22. The heat exchanger as recited in claim 16, wherein the fin is made of a JIS A3000 series alloy.

23. A method of manufacturing a heat exchanger, comprising the steps of:
preparing a brazing heat exchanging tube by spraying the aluminum alloy brazing material defined by claim 1 onto a surface of an aluminum or aluminum alloy heat exchanging tube substrate to form a brazing layer; and
brazing the brazing heat exchanging tube and the fin via the brazing layer of the brazing heat exchanging tube by heating both of the brazing heat exchanging tube and the fin in a combined manner.

24. The method of manufacturing a heat exchanger as recited in claim 23, wherein the step of preparing the brazing heat exchanging tube is performed by forming the heat exchanging tube substrate by extrusion and subsequently spraying an aluminum alloy brazing material onto the heat exchanging tube substrate.

25. The method of manufacturing a heat exchanger as recited in claim 23, wherein the step of brazing is performed under normal pressures.
